(19) United States
(12) Patent Application Publication
(10) Pub. No.: US 2017/0355626 A1
(43) Pub. Date: Dec. 14, 2017

(54) PORTABLE ELECTROLYTIC WATER PURIFIER

(71) Applicant: Hsin-Mao HSIEH, Kaohsiung City (TW)

(72) Inventor: Hsin-Mao HSIEH, Kaohsiung City (TW)

(21) Appl. No.: 15/181,100

(22) Filed: Jun. 13, 2016

(51) Int. Cl. C02F 1/461

(52) U.S. Cl. CPC C02F 1/46109; C02F 2001/46152; C02F 2201/46165; C02F 2201/002

(57) ABSTRACT

A portable electrolytic water purifier includes a housing, a base, a first conducting grid plate, a second conducting grid plate and an electrolytic circuit module. The housing has a container coupling portion. The base is mounted inside the housing and has an assembly ring connected with the container coupling portion. The second and first conducting grid plates are respectively mounted inside the assembly ring, are overlapped in a top-down manner, and are located under an opening of the container coupling portion. The electrolytic circuit module is mounted inside the housing and is electrically connected to the first and second conducting grid plates. After a container filled with water is inversely placed on the water purifier, the first and second conducting grid plates are immersed in water to decompose the water into electrolyzed water through electrolysis.

### BACKGROUND OF THE INVENTION

### 1. Field of the Invention

The present invention relates to an electrolytic device and, more particularly, to a portable electrolytic water purifier.

### 2. Description of the Related Art

Free radicals have high chemical activity and exist within cells of human body. When excessive free radicals exist within the human body, the free radicals will seize electrons around cells of the human body to become potentially harmful to human health and accelerate body aging. There are many reasons for free radial generation. For example, living environment, dietary habits, lifestyle and the like may cause excessive free radical generation inside the human body. A conventional approach for reduction of free radicals inside the human body is to drink electrolyzed water. Many people then install electrolytic water purifiers at home accordingly. The electrolytic water purifiers are usually connected to drinking water hoses and perform electrolysis of ordinary tap water in generation of electrolyzed water. When users in possession of the electrolytic water purifiers go out, electrolyzed water to be drunk outside may be filled in a bottle beforehand. However, when the electrolyzed water runs out, refilling the bottle with electrolyzed water becomes an issue.

### SUMMARY OF THE INVENTION

An objective of the present invention is to provide a portable electrolytic water purifier for ease of carrying and decomposition of water in a plastic bottle placed on the portable electrolytic water purifier when necessary.

To achieve the foregoing objective, the portable electrolytic water purifier includes a housing, a base, a first conducting grid plate, a second conducting grid plate, and an electrolytic circuit module.

The housing has an internal space and a container coupling portion.

The container coupling portion has an opening communicating with the internal space.

The base is mounted inside the internal space of the housing and has an assembly ring annularly formed on a top surface of the base. An inner wall of the assembly ring abuts against a periphery of the container coupling portion.

The first conducting grid plate is mounted on the top surface of the base, and is located within the assembly ring and underneath the opening of the container coupling portion.

The second conducting grid plate is mounted above and is electrically isolated from the first conducting grid plate, and is located within the assembly ring of the base and underneath the opening of the container coupling portion.

The electrolytic circuit module is mounted inside the internal space of the housing and is electrically connected to the first conducting grid plate and the second conducting grid plate.

Given the foregoing portable electrolytic water purifier, when users go out, the portable electrolytic water purifier can be carried along and combined with a plastic bottle filled with water by inversely placing the plastic bottom on the portable electrolytic water purifier for the first conducting grid plate and the second conducting grid plate to be immersed in the water of the plastic bottle. When the electrolytic circuit module supplies power with reverse polarities to the first conducting grid plate and the second conducting grid plate, water located between the first conducting grid plate and the second conducting grid plate is decomposed into drinkable electrolyzed water through electrolysis. The portable electrolytic water purifier is compact and lightweight for ease of carry. When users go out, the portable electrolytic water purifier can be used to generate electrolyzed water. After one bottle of water is fully decomposed and drunk, another bottle of water can be provided for continuous electrolysis in generation of electrolyzed water. Accordingly, users can supplement electrolyzed water at all time as long as bottled water is available.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a portable electrolytic water purifier in accordance with the present invention;

FIG. 2 is an exploded perspective view of the portable electrolytic water purifier in FIG. 1;

FIG. 3 is a top view of the portable electrolytic water purifier in FIG. 1;

FIG. 4 is a cross-sectional view of the portable electrolytic water purifier taken along A-A in FIG. 3;

FIG. 5 is a cross-sectional view of the portable electrolytic water purifier taken along B-B in FIG. 3;

FIG. 6 is an operational schematic view of the portable electrolytic water purifier in FIG. 1 coupled to a water container; and

FIG. 7 is a partially enlarged cross-sectional view of the portable electrolytic water purifier and the water container in FIG. 6.

### DETAILED DESCRIPTION OF THE INVENTION

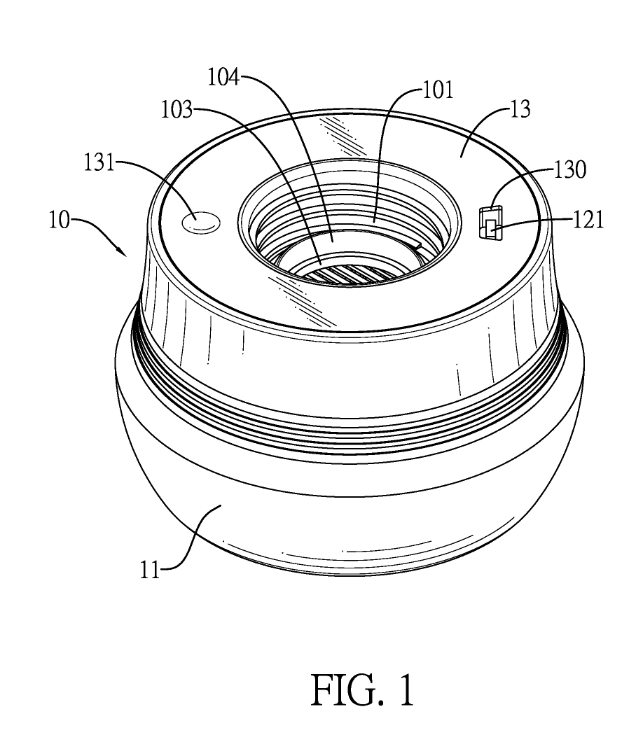

With reference to FIGS. 1 to 3, a portable electrolytic water purifier in accordance with the present invention includes a housing 10, a base 20, a first conducting grid plate 31, a second conducting grid plate 32, an insulation spacer 40 and an electrolytic circuit module 50.

The housing 10 has an internal space 102 and a container coupling portion 101. The internal space 102 is defined inside the housing 10. The container coupling portion 101 is formed through to have an opening 103, a retaining protrusion 104, and threaded portion 101a. The opening 103 is located at a bottom of the container coupling portion 101 and communicates with the internal space 102. The retaining protrusion 104 is annularly formed on and protrudes inwardly and upwardly from a portion of an inner wall of the container coupling portion 101 adjacent to the opening 103. The threaded portion 101a is formed on the inner wall of the container coupling portion 101. The opening 103 may be a circular opening. In the present embodiment, the housing 10 includes a lower seat 11, a fastening member 12 and a cover 13. The lower seat 11 is hollow with an opening facing up and may be rested on a table. The fastening member 12 is mounted inside the lower seat 11 for the internal space 102 defined between the fastening member 12 and the lower seat 11. The fastening member 12 has a flange 120 and the container coupling portion 101. The flange 120 is formed on a top edge portion of a periphery of the fastening member 12, is mounted on a top portion of the lower seat 11, and has an electrical connector 121 mounted inside the flange 120. The electrical connector 121 may be a USB (Universal Serial Bus) connector. The opening 103 is located on a bottom portion of the fastening member 12 formed on and protruding downwardly from an inner wall of the flange 120. The cover 13 is mounted on a top surface of the flange 120 of the fastening member 12 and has a mounting hole 130 and a power switch 131. The mounting hole 130 is formed through the cover 13 and is aligned with the electrical connector 121 of the fastening member 12. The power switch 131 may be a touch button.

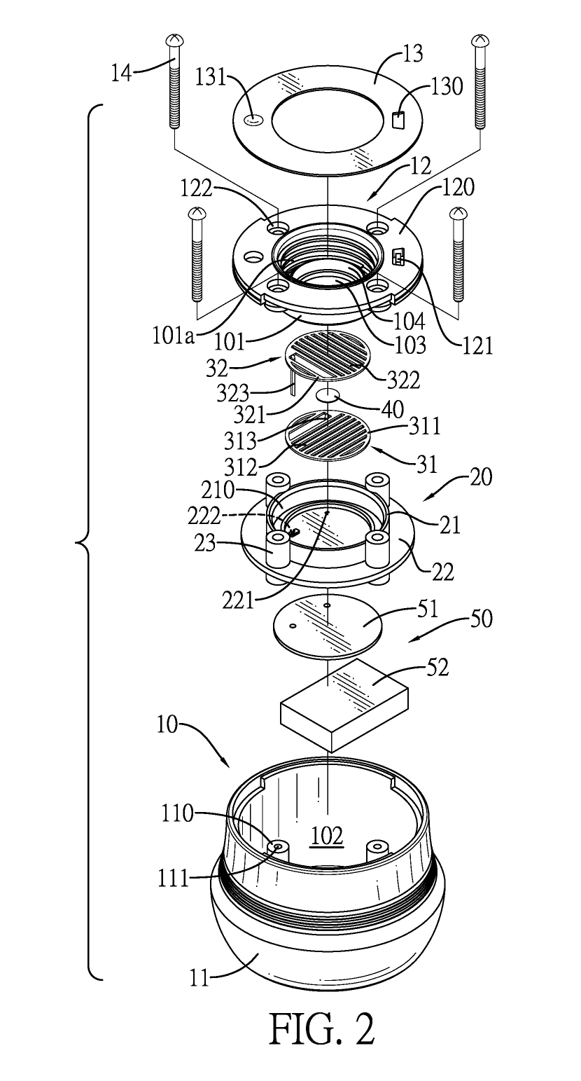

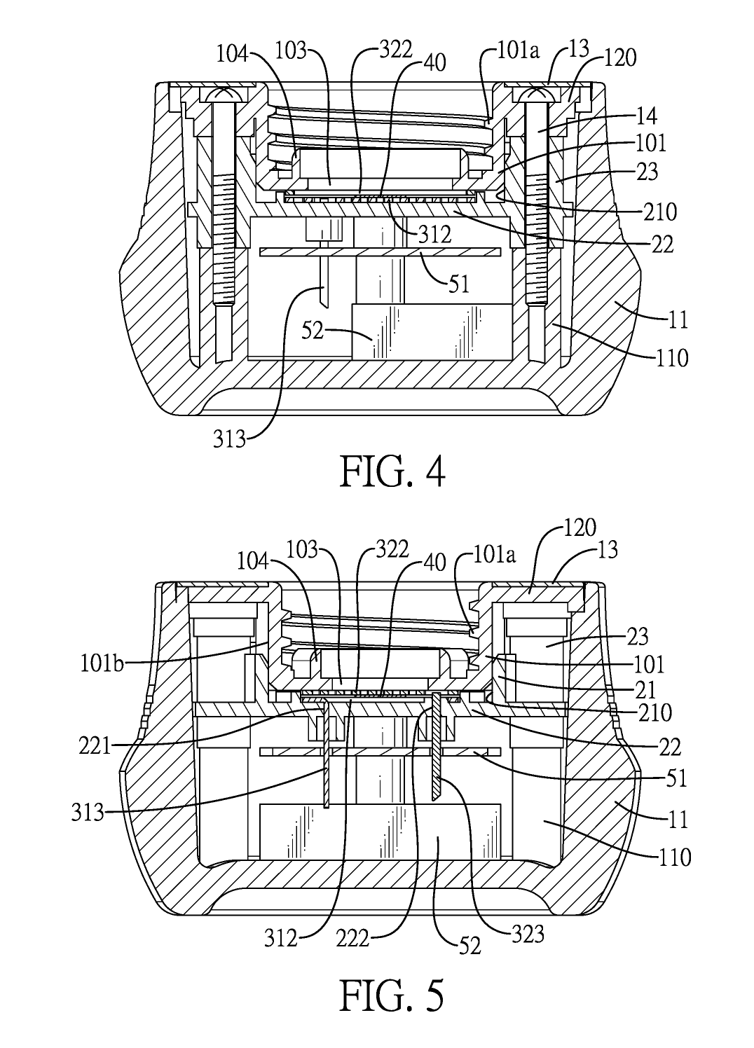

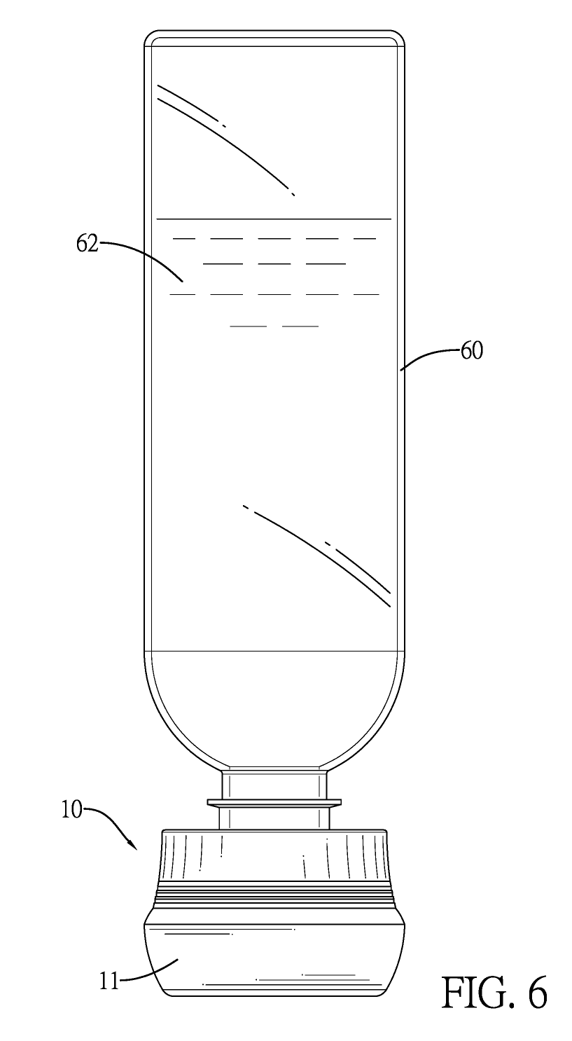

The base 20 is mounted inside the internal space 102 of the housing 10 and has an assembly ring 21. The assembly ring 21 is formed on a top surface of the base 20 and may be annular with a center thereof corresponding to a center of the opening 103 of the container coupling portion 101. A diameter of the assembly ring 21 is greater than a diameter of the opening 103 of the container coupling portion 101. With reference to FIGS. 4 and 5, an inner wall of the assembly ring 21 abuts against a periphery of the bottom portion of the container coupling portion 101. The assembly ring 21 and the container coupling portion 101 may be in tight mating with each other. With reference to FIG. 2, the base 20 has a bottom plate 22 and the assembly ring 21. The assembly ring 21 is formed on a top surface of the bottom plate 22. The bottom plate 22 has a first through hole 221 and a second through hole 222 formed through the bottom plate 22 and separately located within the assembly ring 21.

The first conducting grid plate 31 is mounted on the top surface of the bottom plate 22 and is located within the assembly ring 21 and underneath the opening 103 of the container coupling portion 101. In the present embodiment, the first conducting grid plate 31 has a first frame 311 and multiple first bars 312. The first frame 311 may take a form similar to that of the assembly ring 21, such as a circular frame. An outer diameter of the first frame 311 is greater than an outer diameter of the opening 103 of the container coupling portion 101. The first bars 312 are coplanar with the first frame 311 and are formed inside the first frame 311 and spaced apart from each other by gaps. The first frame 311 has a first pin 313 formed on and protruding downwardly from a bottom of the first frame 311 and mounted through the first through hole 221 of the bottom plate 22 of the base 20. The first frame 311 and the first bars 312 are made from a titanium alloy and have a silver coating formed on a surface of the titanium alloy.

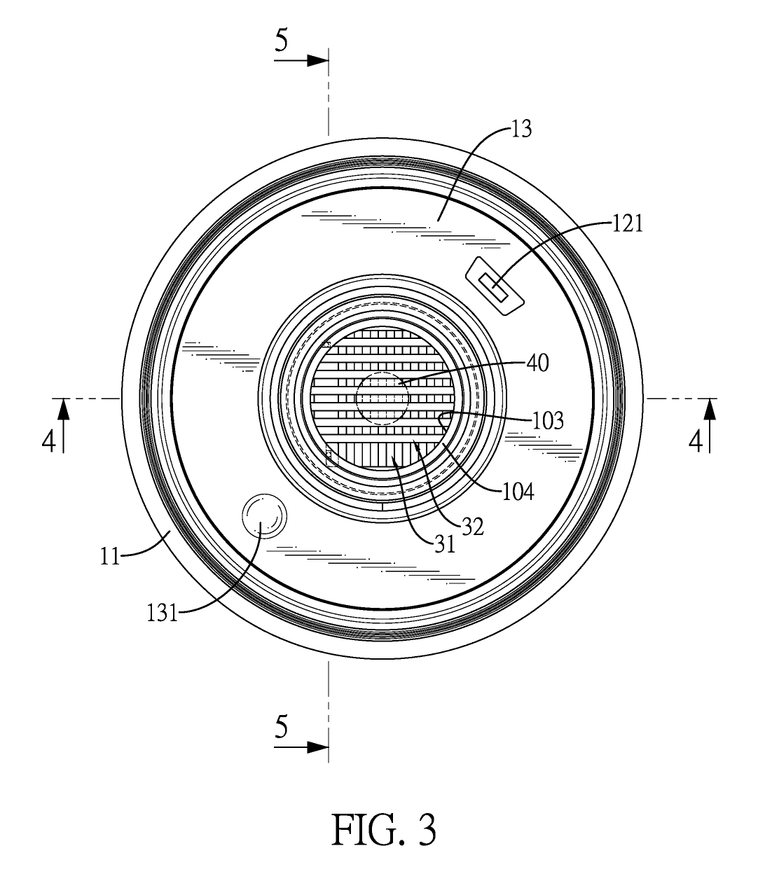

The insulation spacer 40 is mounted on a top surface of the first conducting grid plate 31. With reference to FIG. 3, the insulation spacer 40 is smaller than the opening 103 of the container coupling portion 101 in area. In the present embodiment, the insulation spacer 40 is a circular plate with a diameter less than that of the opening 103 of the container coupling portion 101. For example, the diameter of the insulation spacer 40 is less than half of that of the opening 103 of the container coupling portion 101.

The second conducting grid plate 32 is mounted on a top surface of the insulation spacer 40 for the first conducting grid plate 31 and the second conducting grid plate 32 to be separately mounted below and above the insulation spacer 40. The second conducting grid plate 32 is located underneath the opening 103 of the container coupling portion 101. In the present embodiment, the second conducting grid plate 32 is structurally the same as the first conducting grid plate 31. The second conducting grid plate 22 has a second frame 321 and multiple second bars 322. The second bars 322 are coplanar with the second frame 321 and are formed inside the second frame 321 and spaced apart from each other by gaps. The second frame 321 has a second pin 323 formed on and protruding downwardly from a bottom of the second frame 321 and mounted through the second through hole 222 of the bottom plate 22 of the base 20. The second frame 321 and the second bars 322 are made from a titanium alloy and have a silver coating formed on a surface of the titanium alloy. When the second conducting grid plate 32 and the first conducting grid plate 31 are mounted on the base 20, the second bars 322 are aligned in a direction perpendicular to a direction in which the first bars 312 are aligned. As illustrated in FIG. 3, the second bars 322 and the first bars 312 are overlapped to take the form of a mesh.

The electrolytic circuit module 50 is mounted inside the internal space of the housing 10 and is electrically connected to the first conducting grid plate 31 and the second conducting grid plate 32 to supply power to the first conducting grid plate 31 and the second conducting grid plate 32 with different polarities for electrolysis. For example, when the first conducting grid plate 31 is connected to the anode of a power source of the electrolytic circuit module 50, the second conducting grid plate 32 is connected to the cathode of the power source. In the present embodiment, the electrolytic circuit module 50 includes a circuit board 51 and a rechargeable battery 52. The circuit board 51 is electrically connected to the rechargeable battery 52, the first pin 313, the second pin 323 and the electrical connector 121 and the power switch 131 of the housing 10. The rechargeable battery 52 supplies the power for electrolysis, and the circuit board 51 is controlled by the power switch 131 to output the power for electrolysis to the first conducting grid plate 31 and the second conducting grid plate 32.

As to a combined structure of the fastening member 12, the base 20 and the lower seat 11, with reference to FIGS. 2 and 4, the flange 120 of the fastening member 12 has multiple fixing holes 122 formed through the flange 120, the bottom plate 22 of the base 20 has multiple upper cylindrical bosses 23 formed through the bottom plate 22 and aligned with the respective fixing holes 122, and the lower seat 11 has multiple lower cylindrical bosses 110 formed on an inner bottom of the lower seat 11 and aligned with the respective fixing holes 122 of the fastening member 12. Each upper cylindrical boss 23 has a threaded hole formed through the upper cylindrical boss 23, and each lower cylindrical boss 110 has a threaded hole formed in a top thereof. As illustrated in FIG. 4, the upper cylindrical bosses 23 of the base 20 are respectively connected between a bottom surface of the flange 120 and the tops of the lower cylindrical bosses 23 of the base 20. Multiple screws are sequentially and respectively mounted through the fixing holes 122 of the fastening member 12, the upper cylindrical bosses 23 of the base 20 and the lower cylindrical bosses 110 of the lower seat 11 to fasten the fastening member 12, the base 20 and the lower seat 11 together through threaded connection. The cover 13 of the housing 10 is mounted on the top surface of the flange 120 to cover the fixing holes 122 for aesthetic concerns.

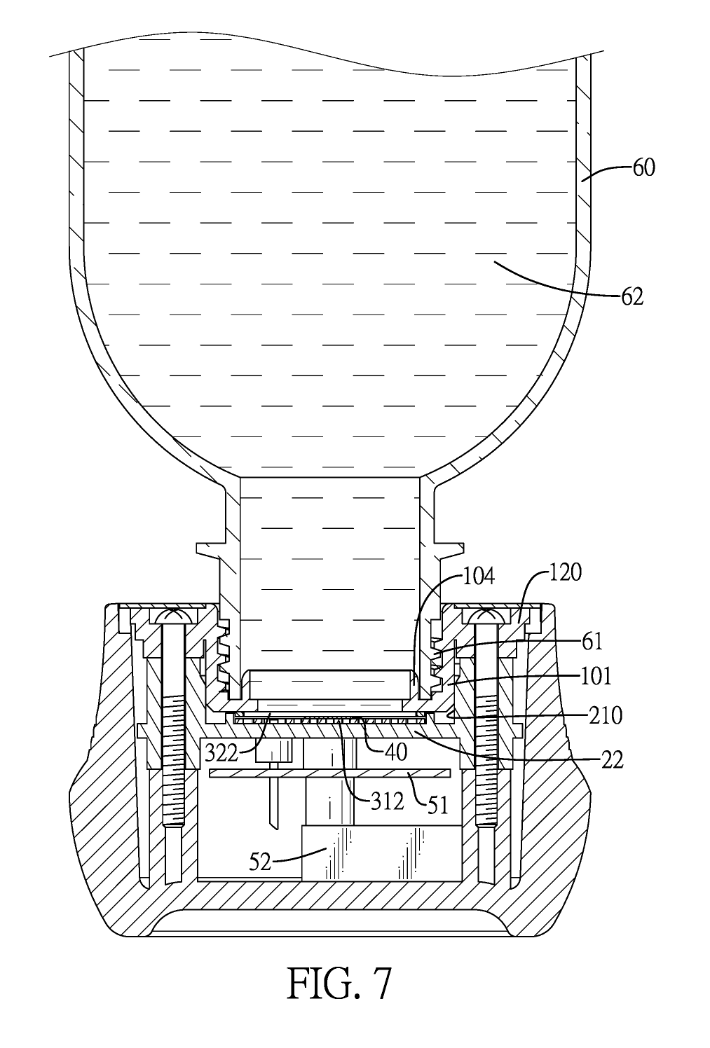

With reference to FIGS. 6 and 7, when the portable electrolytic water purifier is in use, after a container 60 is filled with water 62, a mouth 61 of the container 60 is connected with the container coupling portion 101, such that a water-filling space of the container 60 to communicate with the opening 103 of the container coupling portion 101 and the container 60 is inversely placed with the mouth 61 facing down. Thus, the housing 10 of the portable electrolytic water purifier can be rested on a table. As the container 60 is inversely placed and the insulation spacer 40 is smaller than the opening 103 of the container coupling portion 101, water 62 flows through the mouth 61 to a portion of the base 20 surrounded by the assembly ring 21. Also because the assembly ring 21 and the container coupling portion 101 are in tight mating with each other, water 62 is hermetically retained in the portion surrounded by the assembly ring 21, and the first conducting grid plate 31 and the second conducting grid plate 32 are immersed in water 62. As such, when the circuit board 51 supplies power with opposite polarities for electrolysis to the first conducting grid plate 31 and the second conducting grid plate 32, water 62 can be decomposed to electrolyzed water.

In sum, in contrast to regular electrolytic water purifiers, the portable electrolytic water purifier in accordance with the present invention is compact and lightweight for ease of carry. When going out, users can combine a plastic bottle containing water with the portable electrolytic water purifier. After the bottle is inversely placed and the power switch 131 is switched on, the first conducting grid plate 31 and the second conducting grid plate 32 start performing electrolysis of water and electrolyzed water decomposed from water in the plastic bottle is available for users to drink after a while since the start of the electrolysis.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A portable electrolytic water purifier, comprising:
a housing having:
an internal space; and
a container coupling portion having an opening communicating with the internal space;
a base mounted inside the internal space of the housing and having an assembly ring annularly formed on a top surface of the base, wherein an inner wall of the assembly ring abuts against a periphery of the container coupling portion;
a first conducting grid plate mounted on the top surface of the base and located within the assembly ring and underneath the opening of the container coupling portion;
a second conducting grid plate mounted above and electrically isolated from the first conducting grid plate, and located within the assembly ring of the base and underneath the opening of the container coupling portion; and
an electrolytic circuit module mounted inside the internal space of the housing and electrically connected to the first conducting grid plate and the second conducting grid plate.

2. The portable electrolytic water purifier as claimed in claim 1, wherein
the first conducting grid plate has:
a first frame; and
multiple first bars formed inside the first frame and spaced apart from each other by gaps; and
the second conducting grid plate has:
a second frame; and
multiple second bars formed inside the second frame, spaced apart from each other by gaps, and overlapping the first bars of the first conducting grid plate to take a form of a mesh.

3. The portable electrolytic water purifier as claimed in claim 2, wherein an insulation spacer is mounted between the first conducting grid plate and the second conducting grid plate.

4. The portable electrolytic water purifier as claimed in claim 3, wherein
the base has a bottom plate, the assembly ring is formed on a top surface of the bottom plate, and the bottom plate has a first through hole and a second through hole formed through the bottom plate and separately located within the assembly ring;
the first frame of the first conducting grid plate has a first pin formed on and protruding downwardly from a bottom of the first frame and mounted through the first through hole of the bottom plate of the base, and the second frame of the second conducting grid plate has a second pin formed on and protruding downwardly from a bottom of the second frame and mounted through the second through hole of the bottom plate of the base; and
the electrolytic circuit module has a rechargeable battery and a circuit board electrically connected to the rechargeable battery, the first pin, and the second pin.

5. The portable electrolytic water purifier as claimed in claim 4, wherein the housing has:
a lower seat;
a fastening member mounted inside the internal space defined between the fastening member and the lower seat and having:
a flange formed on a top edge portion of a periphery of the fastening member and mounted on a top portion of the lower seat; and
an opening located on a bottom portion of the fastening member formed on and protruding downwardly from an inner wall of the flange; and
an cover mounted on a top surface of the flange of the fastening member.

6. The portable electrolytic water purifier as claimed in claim 5, wherein
the flange has an electrical connector mounted inside the flange;
the cover has:
a mounting hole formed through the cover and aligned with the electrical connector of the fastening member; and
a power switch; and
the circuit board of the electrolytic circuit module is electrically connected to the electrical connector and the power switch.

7. The portable electrolytic water purifier as claimed in claim 6, wherein
the first frame of the first conducting grid plate and the second frame of the second conducting grid plate are annular, the first frame and the second frame are greater than the opening of the container coupling portion in diameter; and
the insulation spacer is a circular plate and is smaller than the opening of the container coupling portion in diameter.

8. The portable electrolytic water purifier as claimed in claim 7, wherein
the flange of the fastening member has multiple fixing holes formed through the flange;
the bottom plate of the base has multiple upper cylindrical bosses formed through the bottom plate and aligned with the respective fixing holes, wherein each upper cylindrical boss has a threaded hole formed through the upper cylindrical boss; and
the lower seat has multiple lower cylindrical bosses formed on an inner bottom of the lower seat and aligned with the respective fixing holes of the fastening member, wherein each lower cylindrical boss has a threaded hole formed in a top of the lower cylindrical boss;
wherein the upper cylindrical bosses of the base are respectively connected between a bottom surface of the flange and the tops of the lower cylindrical bosses of the base, and multiple screws are sequentially and respectively mounted through the fixing holes of the fastening member, the upper cylindrical bosses of the base and the lower cylindrical bosses of the lower seat to fasten the fastening member, the base and the lower seat together through threaded connection.

9. The portable electrolytic water purifier as claimed in claim 8, wherein the container coupling portion of the housing has a threaded portion formed on an inner wall of the container coupling portion.

10. The portable electrolytic water purifier as claimed in claim 9, wherein the electrical connector of the fastening member is a USB (Universal Serial Bus) connector.
